(19) United States
(12) Patent Application Publication
(10) Pub. No.: US 2003/0170597 A1
(43) Pub. Date: Sep. 11, 2003

(54) TEACHING AIDS AND METHODS FOR TEACHING INTERVIEWING

(76) Inventor: Edward Allen Rezek, Huntington Beach, CA (US)

Correspondence Address: Squire, Sanders & Dempsey L.L.P., Two Renaissance Square, Suite 2700, 40 North Central Avenue, Phoenix, AZ, 85004-4498, US

(21) Appl. No.: 10/080,775

(22) Filed: Feb. 22, 2002

(51) Int. Cl. G09B 19/00

(52) U.S. Cl. 434/219

(57) ABSTRACT

A system for teaching interviewing includes queries, a cross-reference, a writing medium, and instructions. The queries are for obtaining decisions by a student whether provided descriptions of experience are true for an experience of the student. The cross-reference is accessed by the descriptions of experience to provide personality traits. The writing medium includes a first region for a list of the personality traits obtained via the cross-reference, a second region for a summary of the experience, and a third region for a summary list of the personality traits obtained via the cross-reference, and possibly from other lists of values and morals. The instructions direct the student to complete the regions of the writing medium; and direct the student to retell at least one of the summary of the experience and the summary list in answer to a question during an interview.

### FIELD OF THE INVENTION

Embodiments of the present invention relate to teaching students skills to be used for participating in an interview, for example, a qualifying interview for potential employment.

### BACKGROUND OF THE INVENTION

An employer seeking to fill a position is typically challenged to discover a suitable candidate in a relatively short period of time. The employer's investment in a new employee includes costs for screening candidates, interviewing, entertaining, hiring, training, developing and sustaining the productivity of the new employee, and motivating the new employee to remain with the employer at least until a critical date when the employer fully recoups the investment in the new employee. These costs have become so significant that sophisticated systems of screening and interviewing have been developed to decrease the likelihood of hiring a candidate who cannot or will not remain productive through the critical date. The candidate seeking employment is typically challenged to participate in an interview at least because he or she is not likely to have developed or maintained interviewing skills. Formal education generally does not include exposure to systems of screening and interviewing and good employees may find themselves looking for employment relatively infrequently.

The candidate is motivated to provide answers to the questions that are likely to match what the employer wants to hear. The employer is motivated by the desire to minimize costs to obtain information about the candidate that may indicate that the candidate is likely to be productive in the work environment of the open position or desired career track. Generally, obtaining information is accomplished with a battery of questions put to the candidate by several interviewers, each interviewer keeping a record of the answers given and impressions about the candidate's demeanor during the interview. There may be discussion among interviewers about the candidate. A decision to hire or to continue with screening of other candidates is then made. Faced with the possibility that some candidates may have behaviors unsuitable to the position, some systems of interviewing include situations designed to disarm the candidate, camouflage the intent of the question, or encourage the candidate to reveal information otherwise difficult to directly obtain with suitable accuracy.

Without better methods for training candidates to participate in interviews, the transaction costs paid by employers to fill positions will continue to remain high. These costs, borne essentially universally by employers, are met by decreasing profits or increasing prices for goods and services of the employer. Our society of consumers and shareholders absorbs these costs by earning reduced dividends and by paying unnecessarily high prices for products and services. Improved methods for training candidates to participate in interviews may decrease the transaction costs of hiring, shorten the period from hire date to critical date, and provide competitive advantage to employers who spend less on finding suitable candidates.

Generally, transaction costs for any negotiation may be reduced by enabling the negotiating parties to more efficiently exchange accurate information. Without methods for training parties to negotiate (including, for example, candidates negotiating for employment), transaction costs may remain unnecessarily high.

### SUMMARY OF THE INVENTION

A system for teaching interviewing, according to various aspects of the present invention includes a plurality of queries, a cross-reference, a writing medium, and instructions. The plurality of queries are for obtaining decisions by a student whether provided descriptions of experience are true for an experience of the student. The cross-reference is accessed by the descriptions of experience to provide personality traits. The writing medium includes a first region for a list of the personality traits obtained via the cross-reference, a second region for a summary of the experience, and a third region for a summary list of the personality traits obtained via the cross-reference, and possibly from other lists of values and morals. The instructions direct the student to complete the regions of the writing medium; and direct the student to retell at least one of the summary of the experience and the summary list in answer to a question during an interview.

Students readily and accurately recognize whether a description of experience is true for a particular experience. By obtaining student decisions with respect to descriptions of experience, personality traits are accurately identified as being demonstrated by the experience. The personality traits may be identified using terminology unfamiliar to the student.

By arranging the writing medium with regions for personality traits and an experience summary, the student readily incorporates the personality traits into the experience summary. A retelling of an experience summary that includes mention of personality traits is likely to be delivered naturally by the student as interviewee (e.g., a candidate) in an interview and likely to be remembered favorably by an interviewer.

A method for teaching interviewing, according to various aspects of the present invention includes, in any order: (a) inviting the student to select experiences; (b) directing the student to associate provided descriptions with selected experiences; (c) providing a set of themes corresponding to the descriptions for use in associating members of the set of themes with the selected experiences, wherein each member of the set of themes describes at least one of a personality trait, a value, and a moral; (d) directing the student to describe each selected experience using members of the set of themes associated with the experience; (e) asserting that prompts are in recognizable categories; (f) directing the student to recognize the category and call of a prompt; (g) associating a particular theme with the prompt of a particular category of prompts; (h) directing the student to recall a particular experience that was associated with the particular theme; (i) directing the student to respond to the prompt by retelling the description of the experience; and j) directing the student to conclude with at least one theme associated with the experience. A writing medium that includes a four-part teaching aid may be used by the student to describe a selected experience using members of the set of themes. Some of the above steps may be omitted in various alternative embodiments.

A theme may include a personality trait, a value, or a moral. By teaching the student to associate themes with experiences, a student is better prepared to identify an appropriate experience summary and to use it with its themes to answer a question in an interview than by memorizing and reciting stock answers of the prior art. By drawing a distinction between personality traits, values, and morals, the student more clearly appreciates the importance of themes and, further, is made able to detect themes that may be desired by particular employers or industries.

### BRIEF DESCRIPTION OF THE DRAWING

Embodiments of the present invention will now be further described with reference to the drawing, wherein like designations denote like elements, and:

FIG. 1 is a data flow diagram of a process for preparing for and participating in an interview according to various aspects of the present invention;

FIG. 2 is a more detailed data flow diagram of the process 110 for preparing for an interview of FIG. 1;

FIG. 3 is a more detailed data flow diagram of the process 150 for participating in an interview of FIG. 1;

FIG. 4 is a data flow diagram of a process for teaching a student to perform the methods of FIGS. 1 through 3;

FIG. 5 is a teaching aid for use in the process 204 of FIG. 2 for correlating qualities believed to be desired by an employer and qualities believed to be possessed by a candidate;

FIG. 6 is a teaching aid for use in the process 226 of FIG. 2 for associating brief experience descriptions with selected experiences;

FIG. 7 is a teaching aid for use in the process 228 of FIG. 2 for replacing brief experience descriptions with members of a set of themes;

FIG. 8 is a teaching aid for use in the process 206 of FIG. 2 for distinguishing personality traits, values, and morals;

FIG. 9 is a teaching aid for use in the process 234 of FIG. 2 for preparing a summary of an experience comprising themes; and

FIG. 10 is a teaching aid for use in the process 306 of FIG. 3 for associating experience summaries and themes to questions and prompts that may be presented to the candidate performing the process 150 of FIG. 1.

### DETAILED DESCRIPTION OF THE PREFERRED EMBODIMENTS

The problems described above are solved by use of an interviewing system according to various aspects of the present invention and by use of methods of teaching interviewing. An interview includes any conversation or exchange of information between an interviewer (e.g., one who initially conducts the interview, a group of interviewers acting sequentially or together as a panel) and an interviewee (e.g., a candidate for consideration by the interviewer). The exchange of information may be by any conventional arrangement (e.g., face to face, by telephone, by written correspondence, by email, by network link, by video conference, or by chat room). Interviewing generally includes actions by the interviewee, for example, selecting information to disclose and persuasively presenting information. The interviewee's actions may also include determining the value of particular information to the interviewer, determining what information to provide to the interviewer whether or not the interviewer prompts or asks for such information directly, and initiating or controlling a portion of the interview. The result of a successful interview generally includes a change of position by the interviewer to the benefit of the interviewee (e.g., the interviewee obtains an offer for employment; or the interviewee is considered qualified for an award, honor, membership, position, or future consideration such as membership in a preferred group of candidates for another interview).

Interviewing is a form of negotiation. Negotiation is typically directed to seeking agreement on a business matter, for example, a transaction. The subject matter of interviewing is generally directed to skills, experiences, and characteristics of the interviewee. A result of interviewing may include an agreement on the extent and value to the interviewer of the skills, experiences, and characteristics of the interviewee. When the value of the skills, experiences, or characteristics of a person (e.g., a party to or a subject of a negotiation) is at issue, the negotiation generally includes interviewing.

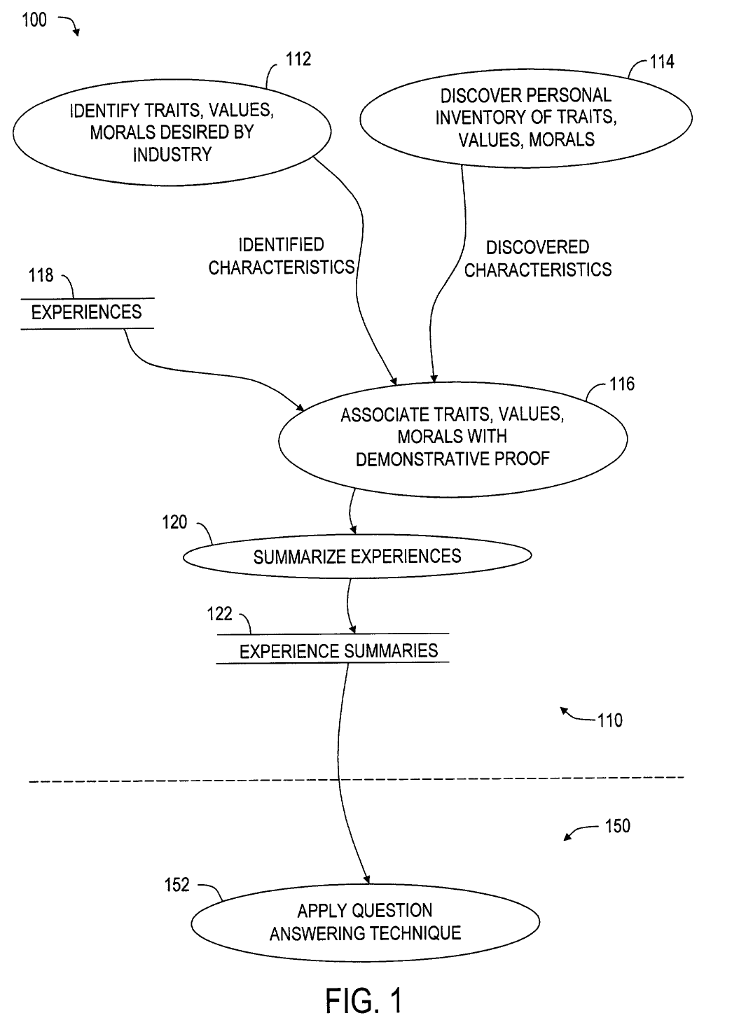

An interviewing system according to various aspects of the present invention motivates and equips the interviewee (herein, interchangeably called a “student”) to provide answers to the interviewer's questions so that the interviewer obtains desired, useful, and memorable information about the experience and character of the interviewee. For example, system 100 of FIG. 1 includes a process 110 performed by the interviewee for preparing for interviews and a process 150 performed by the interviewee for participating in a particular interview. An interviewee may perform the process 150 for participating in a particular interview in a training setting (e.g., initial walk through, mock interview, or drill). In process 110, an interviewee is directed by teaching (e.g., a human teacher, instructor, coach, or counselor; a video presentation; an audio presentation) and/or by self-study printed materials. In process 150, an interviewee is directed by recall of methods learned during the process 110 of preparing for the interview.

Any of the processes of system 100 may be performed when information sufficient for the process is available. In other words, the processes may be performed initially in an order that follows an initial set of information. Later, refinements in the output of any process may be made by repeating any of the processes in any order with additional or revised information.

Process 110 for preparing for an interview includes: a process for identifying 112 personality traits, values, and morals by an industry in which the interviewee desires to be employed; a process for discovering 114 a personal inventory of personality traits, values, and morals; a store 118 of experiences; a process for associating personality traits, values, and morals with demonstrative proof; a process for summarizing 120 experiences; and a store 122 of experience summaries. Personality traits, values, and morals are herein generally referred to as characteristics. These processes cooperate, for example, as follows. A student preparing or being prepared for interviewing through research or advice selects one or more industries in which to seek employment. Through research or advice, the student identifies the characteristics of a person employed in the industry and/or position that is desired by the student. In some cases, the industry (e.g., consumer retail, grocery wholesale, high technology manufacturing) may more clearly distinguish characteristics; while in other cases, the position may be more relevant (e.g., secretary, expediter, accountant). To assure a suitable match of the student's character to the character of one in that industry and position, the student identifies 112 characteristics appropriate to the position. The student also discovers 114 his or her own characteristics. By comparing the identified and discovered characteristics which may be listed in writing or presented orally, the student may determine or be advised whether to pursue the position or search for another that may result in a closer correlation of characteristics. A student draws on his own recollection of past experiences including experiences in family, school, sports, the arts, employments, and business ventures. From that store 118 of experiences, the student selects experiences that tend to exemplify, demonstrate, or prove some or all of the discovered characteristics that are common to the identified characteristics. The result of such association 116 may be recorded as a series of stories set out in writing or presented orally by the student. Finally, the student summarizes 120 each story so that evidence of relevant characteristics may be expressed persuasively. These summaries are stored 122 preferably in writing for use with interviewers in a wide variety of potential interactions.

The student may commit the summarized experiences to memory for recall and presentation orally or in writing at any time. Generally, the summarized experiences are easier to commit to memory than concocted “best answers” to expected interviewing questions of the prior art in part because the summarized answers are based on stories from the students well known life experiences. Answers based on one or more summaries are generally more persuasive than concocted “best answers” of the prior art in part because answers based on summaries include persuasive statements of themes that describe the interviewee in a way more memorable to the interviewer.

Process 150 for participating in an interview includes: applying 152 a question answering technique. Essentially the same technique may be used to answer any and all questions occurring during an interview. By learning and applying essentially the same technique to any question, the student more quickly gains facility with the technique (both in practice sessions and in actual interviews) than in conventional interviewing. In presenting an answer, the student recalls all or portions of one or more experience summaries 122. In an oral interview, the interviewee generally recalls from memory. In a written interview (e.g., a written interview examination, written scholarship request, written request for a research grant), the interviewee may refer to written experience summaries. Reference to memorized or written experience summaries may be made by the interviewee in preparing all forms of communication with an interviewer (e.g., resume, cover letter, employment application, telephone cold calls, introductions, social contacts, telephone interviews, telephone follow up calls, follow up letters, letters of recommendation, letters of negotiation, obtaining cooperation of character references).

According to various aspects of the present invention, a student learns to organize the facts of an experience so as to include facts that prove that a skill, trait, value, or moral is part of the character of the student's experience, and learns to refer to the skill, trait, value, or moral using a succinct terminology, preferably one commonly recognized word. Such a word may be new to the student's vocabulary. Or, a student may not recognize that the abstract definition commonly understood for the word is accurate as a description of his or her character. For example, a student may recognize one of his or her own experiences 118 shows that it took a long time to complete a task and that the student did not give up, but saw the task through to completion. Many students do not recognize, until having learned according to various aspects of the present invention, that this experience demonstrates perseverance. Further, of those students that would recognize perseverance was shown, many do not, until having learned according to various aspects of the present invention, recognize that it is accurate, persuasive, and memorable to an interviewer to include the word “perseverance” in some grammatically correct form in the interview with or without being prompted to do so. Still further, when presented with a prompt or an opportunity during an interview, many interviewees do not use prompt, opportunity, or call of the question to recall the word “perseverance” and then use the word “perseverance” to recall a suitable experience summary so as to retell the experience summary not only with the word “perseverance” as one personality trait but also to mention several other traits, values, and morals during the retelling of the experience. When an interviewer follows the above sequence of recall, not only is the difficulty of recall greatly reduced from the interviewee's point of view, but also, an interviewer efficiently receives many easily remembered characteristics of the interviewee. The interviewer may record these characteristics on a written evaluation of the interviewee or use them in describing the interviewee to others for determining an offer to the interviewee.

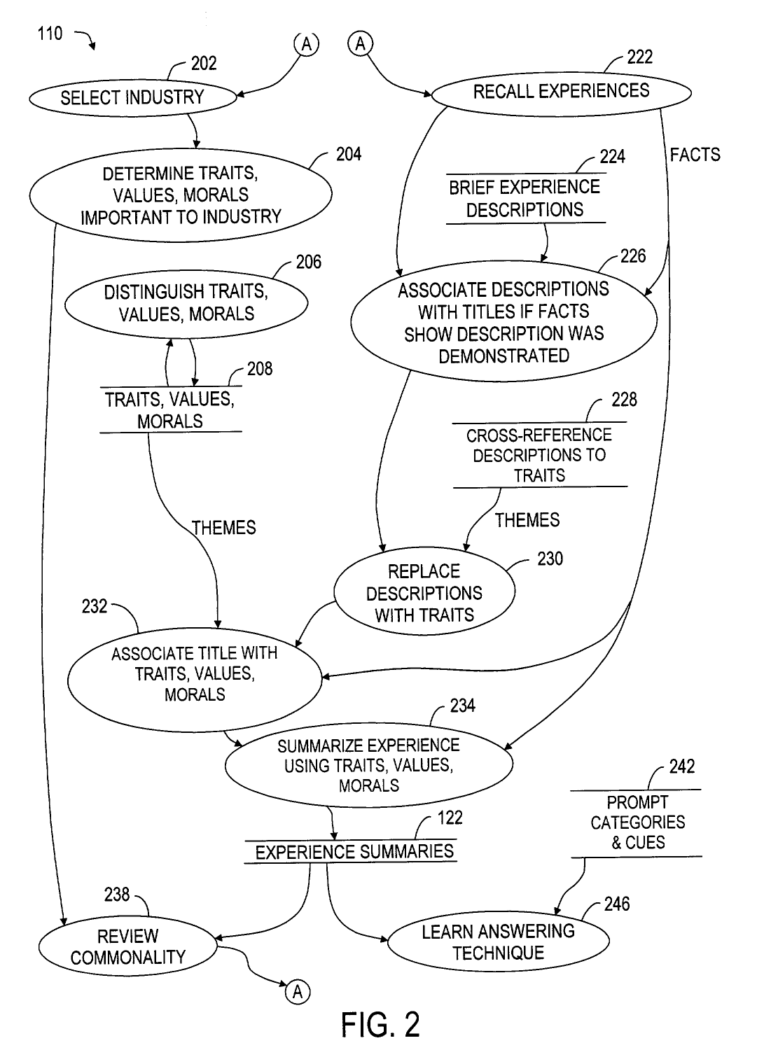

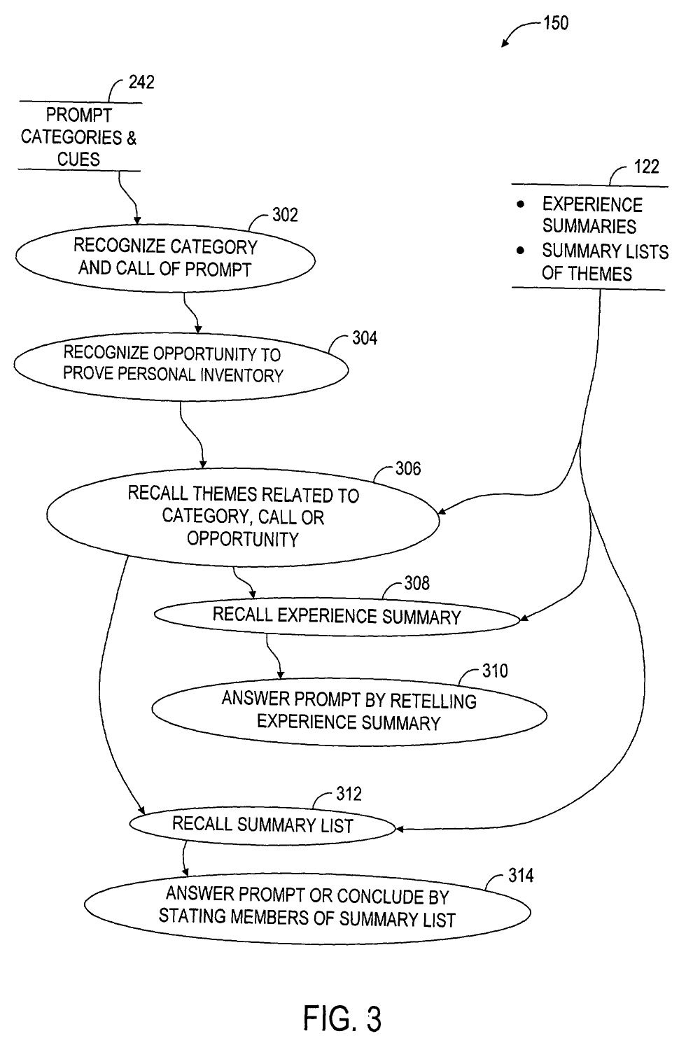

For example, processes 110 and 150 of FIG. 1 may be implemented as shown in FIGS. 2 and 3. As in FIG. 2, process 110 for preparing for an interview includes: a process for selecting 202 an industry and position of interest to the student; a process for determining 204 traits, values, and morals likely to be important to interviewers in the industry seeking to fill the position; a process for distinguishing 206 traits, values, and morals; a store 208 for traits values and morals distinguished by process 206; a process for recalling 222 experiences; a store 224 of brief experience descriptions; a process for associating 226 descriptions from store 224 with titles of experiences from process 222 if facts of the experience show that the description was demonstrated in the experience; a cross-reference store 228 typically accessed by indicia of brief experience description as in store 224 to provide an associated trait; a process for replacing 230, in the associations of process 226, the brief experience description of store 224 with the associated trait of store 228; a process for associating 232 other traits, values, and morals from store 208 with title, traits, values, and morals provided by process 230; a process for summarizing 234 experiences provided by process 222 using traits, values, and morals provided by process 232; a store 122 for experience summaries provided by process 234; a process for reviewing 238 the extent of commonality between traits, values, and morals provided by processes 204 and those associated with experience summaries of store 122; a store 242 of categories of questions an interviewer may encounter during an interview associated with cues for identifying the categories; and a process for learning 246 a question answering technique.

Any of the aforementioned processes may be performed by (and stores maintained by) a student, by a computer system, or by the cooperation of a student and a computer system. Any conventional computer system may be used including, inter alia, a personal computer, a personal digital assistant, a portable phone, a terminal in communication with a server, and preferably a personal computer with a browser and network access (e.g., preferably via the Internet) to a server.

In addition, data used by any process may be entered, recorded, and/or transferred among processes using conventional networking messages (e.g., HTML, XML), shared memory (e.g., any mix of semiconductor and disk) having any conventional data storage organization (e.g., a database, one or more files, data structures, linked lists, records), conventional data entry (e.g., database input screens, browser screens (e.g., HTTP), tables, spreadsheets). All of the above alternatives are capable of accepting and maintaining an association among data items.

An association between data items may facilitate recall or further processing. For example, a title of an experience is associated with a theme by recording a character string for each in a manner that includes indicia that the character strings are related. The association may be due to the manner of being inputted (e.g., in the same row or column of a worksheet, or on the same or related pages of a workbook), due to the manner of being stored (e.g., in a linked list or common record), due to the manner of being communicated (e.g., in the same message, in the same header), or in a manner facilitating recall or processing as a group (e.g., knowledge of theme facilitates recall of title, retelling of an experience facilitates recall of other themes associated with the same title).

Process 202 for selecting an industry may use conventional materials available to employment guidance counselors including, for example, publications of the US Department of Labor. On self-analysis or counseling, industries that are of interest to the student are listed. For each industry one or more positions may be identified and selected. Each industry and position is provided to process 204.

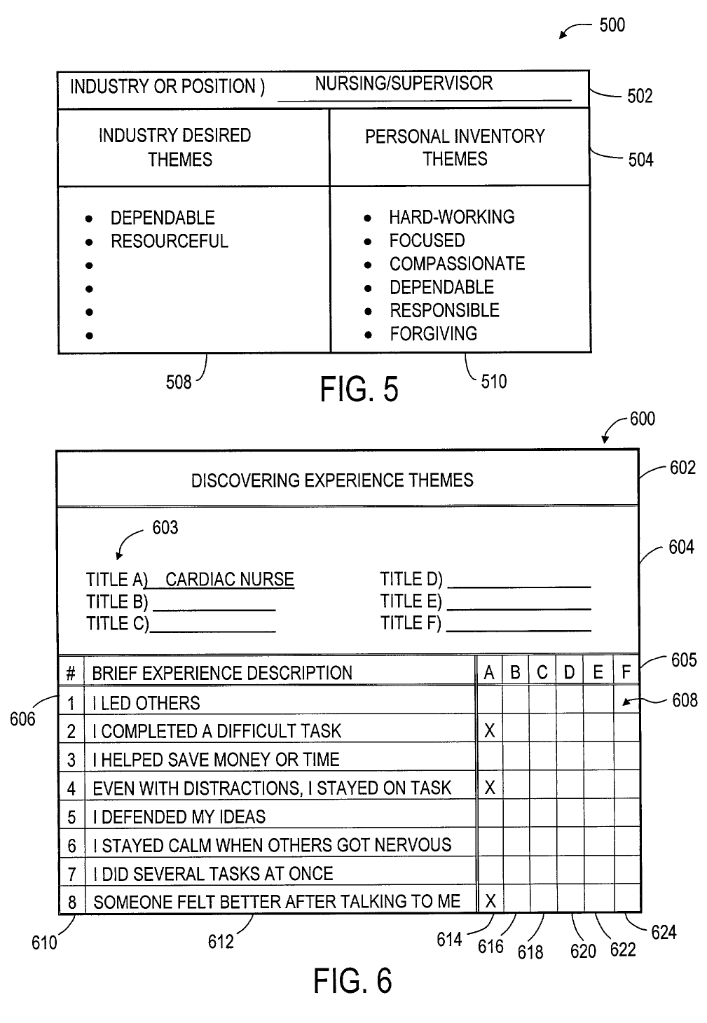

Process 204 for determining characteristics important to the industry and position may use conventional materials available to employment guidance counselors including, for example, information gathered and maintained by corporate human resources departments, educators, and employees with experience in the industry or position. Process 204 may provide a title of the industry and/or position in association with a list of personality traits, values, and morals. The format of FIG. 5 may be used.

Any medium for recording a writing (e.g., making a written record) may be used. Writing may be manual or electronic (e.g., entry/edit). All types of media are herein generally referred to as a worksheet, or in the plural as worksheets or a workbook. A worksheet may be presented as a table, a list, one or more dialog boxes, or one or more screens. Worksheets may be in any media suitable for manual use (e.g., handwriting) or automated use (e.g., keyboard entry, voice responsive entry).

A worksheet may be used for input, storage, or transfer of information so as to associate or maintain an association between a title of the industry and/or position and a plurality of characteristics. For example, worksheet 500 includes a heading 502 that includes the title of the industry and/or position, a table 504 that includes a list 508 of themes considered important to the industry and/or position, and a list 510 of themes of the student's personal inventory. The lists 508 and 510 may have an association among elements (e.g., an item in list 508 corresponds to an item of list 510 in the same row), may have a one-to-many or many-to-one relation between items, or may have no organized relationship between items. Process 204 may provide list 508 while process 238 may obtain list 510 from store 122.

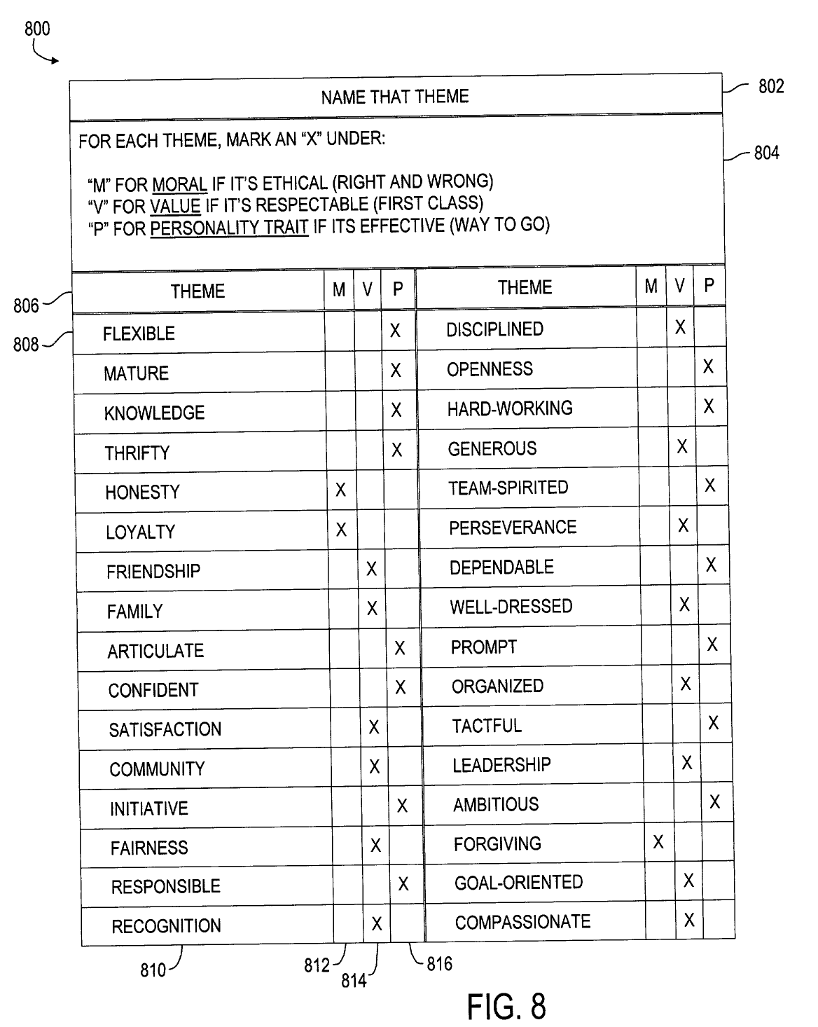

Process 206 for distinguishing characteristics includes any method that accomplishes a higher level of student understanding about one or more of the following: (a) vocabulary that is accurate and effective to use to describe his or her character; (b) whether or not particular facts support a conclusion that a characteristic was demonstrated; and (c) characteristics that are typically sought after and appreciated by interviewers. Process 206 may direct the student to begin with a blank list to define all entries in store 208. A method of process 206 may include exposing the student to a large number of words that may be used as themes; inviting the student to draw distinctions among them; encouraging the student to consider how each term conveys a definite, though possibly abstract, idea; and asserting that these words and the themes they convey are typically valued and appreciated by interviewers. Information in the format of FIG. 8 may be used.

A worksheet may be used for input, storage, or transfer of information so as to associate or maintain an association between a name of a theme (e.g., a short phrase, a word in any grammatical form), herein simply called a theme, and indicia of whether that theme expresses a personality trait, a value, and/or a moral. For example, worksheet 800 includes heading 802, directions 804, table 806 formatted for convenience in two parallel sections, each section having rows 808 and columns 810, 812, 814, and 816. The row/column intersections facilitate the association of a theme (e.g., “flexible” in col. 810) with one or more of a moral (col. 812), a value (col. 814), and/or a personality trait (col. 816). A theme may be expressed in any convenient part of speech, for example, as a noun (e.g., “friendship”), an adjective (“thrifty”), or a participle (e.g., “forgiving”, “organized”).

By distinguishing themes as at least one of a personality trait, a value, and a moral, the student is challenged to consider three different value systems.

Characteristics that are members of a first value system seem to contribute to task oriented on-the-job effectiveness (e.g., ability to accomplish tasks with little supervision, ability to accomplish tasks without aggravating others, ability to follow directions with little waste of time or resources). These are herein called personality traits. Many interviewers strongly favor interviewees that exhibit these characteristics. Process 110 directs the student to strongly associate personality traits with experiences to facilitate recall as discussed above.

Characteristics that are members of a second value system seem to contribute to social status, in other words, earning the respect of others (e.g., leading to acceptance of the person by others, leading to the formation of trust between the person and others, leading to others being easily persuaded by the person). These are herein called values. Values may contribute to effectiveness in supervising, advising, or managing others.

Characteristics that are members of a third value system seem to contribute to the integrity of the person. If a person believes that a particular behavior is ideal, or that failure to exhibit the behavior in favor of personal gain is reprehensible, the student is encouraged to distinguish those characters corresponding to such behavior as what is herein called morals. Such beliefs may have been instilled in the student through parental guidance, religious training, emersion in group, team, couple, family, or community relationships, trauma, or real or imagined losses. Process 208 encourages the interviewee to appreciate morals in his or her inventory of characteristics. Among other things, the cooperation of processes 206, 232, and 234 equips an interviewee to suitably persuade an interviewer who appreciates morals, without traversing the interviewer's limitation to avoid posing illegal questions.

The student need not come to the same appreciation of these value systems as anyone else (e.g., the teacher, the teaching materials, other students, or interviewers). Process 206 is aimed at causing the student to come to appreciate that interviewers may be weighing the suitability of the interviewee on one or more of these three value systems. Whether a theme is one or more of a moral, a value, and/or a personality trait may be left to the judgment of the student.

Process 222 for recalling any of his or her personal experiences includes any method that directs a student to indicate at least a title of a personal experience to facilitate referring to the experience in other processes. By recalling an experience and associating a title to it, facts surrounding the experience may be prompted to be recalled for use in other processes of process 110 by referring to the title. A student may be encouraged to write a narrative of the experience and associate the title to the narrative.

A store of brief experience descriptions includes any medium that provides access to statements and prompts for describing experiences. Access may be one at a time, grouped, or all at once. According to various aspects of the present invention, a phrase or statement is useful as a brief description to the extent that it defines a theme, exemplifies a theme, or negates an opposite of a theme. Table 1 includes a preferred set of brief experience descriptions associated with a corresponding (e.g., primary) theme each one suggests. In one implementation, store 224 includes the contents of Table 1. The set of brief experience descriptions may be compact for simplicity or may include redundancy. Redundancy may teach by repetition, overcome misunderstandings (e.g., initially limited student vocabulary), or encourage a student to discover themes and/or recall additional experiences (e.g., interrupting process 226 to repeat process 222).

TABLE 1

| # | Brief Experience Description | Theme |
|---|---|---|
| 1 | I led, motivated, or convinced others | Leadership, Influential, |
| | while completing a task | Team-oriented |
| 2 | I completed a difficult task | Successful |
| 3 | I had a problem with a task and figured | Analytical, Methodical |
| | a way to solve it | |
| 4 | I had a problem with a person while | Communication, |
| | working on a task and fixed the | Understanding |
| | situation | |
| 5 | I completed a task, even after | Perseverance, Forceful |
| | experiencing stress or resistance from | |
| | others | |
| 6 | I helped save money or time on a task | Efficient, Improve |
| 7 | Although there were distractions, I | Single-minded, Focused, |
| | stayed on the task | Driven |
| 8 | Other people's ideas helped improve the | Open-minded |
| | task | |
| 9 | I defended my ideas when they were | Brave, Forthright, |
| | questioned | Confident |
| 10 | I changed my approach when I learned | Flexible, Adaptable |
| | new things about the task | |
| 11 | I changed my approach when I heard a | Team-oriented, Open- |
| | good idea from someone else | minded |
| 12 | The task did not succeed, but I learned | Mature |
| | from it | |
| 13 | I figured out what steps to take to | Organized |
| | complete the task | |
| 14 | On my own, I found out new things | Curious, Inquisitive, |
| | about my task | Experimental |
| 15 | I stayed calm during a task, while the | Confident, Mature |
| | task or others were getting nervous | |
| 16 | I understood something about the task | Observant, Insightful |
| | that was not obvious to others | |
| 17 | I did not consider the task to be | Dedicated, Quality-minded |
| | complete when it was less than | |
| | satisfactory | |
| 18 | Others trusted my opinion | Leadership |
| 19 | I performed the task well, using training | Methodical, Detail- |
| | or a procedure | oriented, Disciplined |
| 20 | I made a decision based on my plans for | Goal-oriented, Ambitious |
| | the future | |
| 21 | I was able to tell someone how to | Tactful, Diplomatic |
| | improve without hurting their feelings | |
| 22 | Someone felt better after talking to me | Understanding, |
| | about a problem | Compassionate |
| 23 | I was able to perform successfully on | Organized, Balanced |
| | more than one task at a time | |
| 24 | I was able to help keep others going | Energetic, Enthusiastic |
| | when the task became difficult | |
| 25 | I was always there to do my part on the | Dependable, Prompt |
| | task | |
| 26 | I share what my real thoughts are on the | Honest, Truthful |
| | task | |

Process 226 for associating brief experience descriptions with experiences includes any method for describing an experience in terms related to one or more personality traits, values, or morals. For example, process 226 may include associating each experience recalled by process 222 with a title, a reference indicator, or both; for each experience and for each of several brief experience descriptions, considering whether or not the brief experience description seems to be supported by facts of the experience. A worksheet in the format of FIG. 6 may be used.

A worksheet may be used for recording the association between a brief experience description and an experience and further facilitate replacing brief descriptions with traits as discussed below with reference to process 230. For example, worksheet 600 includes heading 602; table 604 for associating each experience title with a reference letter 603 (e.g., A-F for six experiences); and table 605 comprising rows 606, each row for associating a brief experience description (col. 612) that is numbered for reference (col. 610) with each experience identified by the reference letter atop a column (e.g., col. 614 for experience A) of check boxes. The student is directed to consider each experience and each brief description and place an “X” in the check box if the facts of the experience seem to demonstrate the brief experience description.

The worksheet of FIG. 6 is illustrated as already used by a student who has entered a title (“Cardiac Nurse”) for a prior employment experience and referred to that experience in column 614 by the common letter designation “A”. For that experience, the student marked the check boxes in column 614 only when the student agreed with the statements in column 612, that is, the brief experience descriptions (e.g., identified by reference numbers as 2, 4, and 8). As discussed above, the list of brief experience descriptions may be any length. The preferred set of 26 brief experience descriptions of Table 1 may be used. Any number of experiences may be described. The student may be directed to divide into several experiences an experience to which many brief experience descriptions seem to apply. The student may be encouraged (e.g., repeat process 222) to develop a set of experiences from 2 to 10 (e.g., six as shown in FIG. 6) that together demonstrate a majority of the brief experience descriptions.

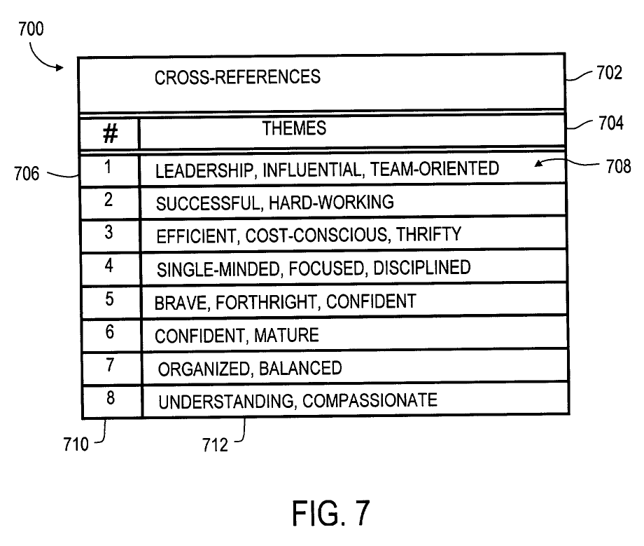

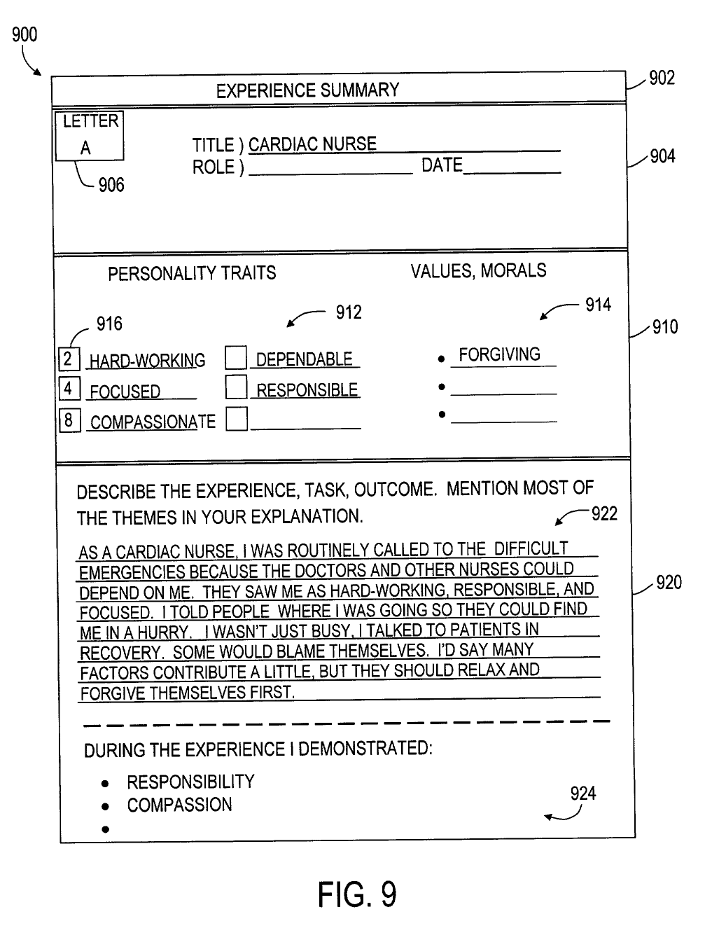

A cross-reference of brief experience descriptions to themes may be a direct cross-reference or may use one or more intermediate identifiers. The cross-reference may be a printed teaching aid, a data structure, a file, or a database. For example, themes corresponding to the brief experience descriptions in column 612 of FIG. 6 are identified in worksheet 700 of FIG. 7. Worksheet 700 includes a heading 702; and a table 704 for associating each reference number with a list 708 of alternative themes. Table 704 includes a column 710 of reference numbers and a column 712 of lists. Each row 706 includes a cross-reference of one brief experience description of FIG. 6 to a list of themes 708 according to common reference numbers in columns 610 and 710. In a preferred implementation, lists 708 consists of personality traits as used, for example, in column 810 of FIG. 8. In another implementation, personality traits, values, and morals are suitably included in list 708 to account for the differences in understanding, and interpretation of themes as discussed above with reference to FIG. 8. In another implementation store 228 includes a list 708 (e.g., not necessarily unique) for every brief experience description of store 224.

Process 230 for replacing brief experience descriptions with themes includes any method for promoting discovery by the student of his or her inventory of personality traits, values, and morals. For example, process 230 may include reviewing the associations made by process 226 and associating themes with each experience, experience title, or each brief experience description. In an implementation where no further reference is made to the brief experience descriptions, each association of a brief experience description to an experience may be revised to associate a theme in place of the brief experience description. In a preferred implementation, the association of personality traits with experiences is facilitated by use of a worksheet, for example worksheet 900, discussed below.

For example, on a worksheet 900 that has been identified (e.g., by title) for a particular experience (e.g., “Cardiac Nurse”), brief experience descriptions numbered 2, 4, and 8 in col. 610 may be noted by number in boxes 916 of section 912. Then, for each numbered box 916, a corresponding theme list 708, 712 of the same number (e.g., entries in col. 710 match entries in col. 610) may be reviewed (e.g., “successful, hard-working” in row numbered 2 in col. 710). The student is directed to pick one of the themes (e.g., one that seems easy to remember, accurate, or persuasive). For each numbered item 2, 4, and 8 in section 912 of worksheet 900, the student then enters the chosen word from a row of worksheet 700.

Process 232 for associating an experience title with themes includes any method for expanding the set of associations provided by process 230 to include associations of the same titles with additional themes drawn from store 208. These further associations may be recorded on a worksheet with the associations made by process 230. For example, the student may review col. 816 of worksheet 800 of FIG. 8, recall additional facts about the experience and recognize that “responsible”, “dependable”, and “forgiving” seem to be demonstrated by his or her experience titled “Cardiac Nurse”. Using the worksheet 900 of FIG. 9, these themes, in any order, may be added to sections 912 and 914 according to the student's view of these themes as personality traits, values, or morals.

Process 234 for summarizing an experience using themes includes any method for preparing an outline or a narrative that indicates facts selected as demonstrative of particular themes associated with the experience as discussed above. A summary is prepared for each of as many experiences as may be available to demonstrate most if not all themes related to the industry and position identified by process 202. The summaries may be rehearsed orally until the student is able to recall each with accuracy. Alternatively, the student may prepare a written record of each summary. Preferably, the student prepares each summary on a worksheet for study, rehearsal, and reference when preparing any communication with prospective employers. For example, worksheet 900 of FIG. 9 includes heading 902; section 904 for identifying one experience to be summarized; section 910 for associating themes with the experience identified in section 904; and section 920 for recording a written experience summary and a summary list of themes.

Section 904 includes a box 906 for entry of a reference symbol that may have been associated with the experience (e.g., a letter 603 of worksheet 600). If reference symbols have not been used, box 906 may be omitted. Section 904 further includes a space for recording the title of the experience, a role played by the student in the experience, and a date when the experience occurred. A role describes the relative responsibility of the student and/or the interaction with others in the experience if the experience involved more people than the student alone. By associating a specific date with the experience, the student is better prepared to answer a query regarding date or sequence of events, thereby further supporting a conclusion that the student is able to reliability recall pertinent information both during the interview and potentially in the offered position.

Section 910 provides an orderly presentation of themes and distinguishes personality traits from the other two types of themes, namely, values and morals. Section 910 includes section 912 for recording personality traits and section 914 for recording values and morals. By recording themes in an orderly presentation, a student directed to write a summary of the experience may move quickly and efficiently from a listed theme, recall of supporting facts, and statement of narrative. Because interviewers generally attach high value to effectiveness on the job and because the time allowed for an interview is usually relatively short, the student is directed to develop brief, clear, and persuasive narrative statements that include the themes (e.g., especially the personality traits) in the exact word form listed in section 910 or a word form that is merely a grammatical variation. For example, to describe the trait listed in section 912 as “focused” the student is directed toward using one of the words “focus”, “focused”, focusing”, as opposed to words and phrases that may be felt to be similar, such as, “I saw what needed to be done”, “we were clear about it”, “we had some distractions”, “we kept looking toward our goal”. As discussed above, succinct use of a form of a widely accepted name of the theme (e.g., here the word “focus”) effectively persuades the interviewer and provides something the interviewer can more easily remember for effective recall when describing the interview or the interviewee to others.

Worksheets of FIGS. 5, 6, 8, and 9 have been completed on a consistent basis as an example of various aspects of the present invention. Of course, worksheets in FIGS. 5, 6, 8, and 9 would be available in blank and in sufficient quantity for drafts and final versions prepared by the student.

Store 122 may include an instance of worksheet 900 for each experience. Alternatively, store 122 may be organized as a database for storage and recall of the data and relationships of one or more types of worksheets, worksheet 900 being but one of the types. In one implementation, all stores described herein are part of one database.

Process 238 for reviewing commonality (if any) between themes of experience summaries and themes related to an industry and position. Each industry and position may be considered in turn for comparison for commonality with the same or a different group of experience summaries. For example, process 238 may include listing themes from section 910 of one or more experience summaries (e.g., preferably all experience summaries) in any order in column 510; identifying industry themes from column 508 that do not appear in column 510; providing the list of themes in column 510 to select industry and position process 202 so as to identify alternate and additional industries or positions that have most or all of these themes indicated as important to the industry or position; and providing the list of themes not found in column 510 to recall experiences process 222 so as to identify alternate and additional experiences to be summarized.

A store of prompts, categories, and cues provides information used to learn how to respond to a prompt. Prompts include statements, questions, silences, opportunities to initiate dialog or to provide information (e.g., introducing oneself, cold calls, resumes), and opportunities to respond according to etiquette with additional information (e.g., requests for information, answering interview questions, “thank you” letters). By grouping prompts into categories, a common set of cues may be recognized among the prompts. Cues may be used to identify a category, and the category used to recall a technique for responding to the prompt. For example, Table 2 describes prompts, categories, and cues that may be stored and accessed from store 242.

TABLE 2

| Prompt | Description |
|---|---|
| What was your favorite subject in school? | These are prompts of the likes/dislikes type. |
| What did you like best about it? | The interviewer expresses curiosity about the |
| What do you think you'll like least about the | interviewee's personal preferences. Cues |
| job you're interviewing for? | include use of the words “like”, “favorite”, |
| What interests you about a career with this | “best”. “dislike”, “worst”, “interests”, and |
| company? | “appeal”. Cues include subject matter such as |
| If you could change anything about your | hobbies, sports, and other non-employment |
| previous jobs, what would it be and why? | pastimes. One technique for responding directs |
| What was the last book you read, movie you | the interviewee to very briefly answer with |
| saw, or sporting event you attended? | what the interviewee likes and give a reason. |
| What aspects of our organization appeal to | The better reason explains that the like/dislike |
| you? | is related to one of the interviewee's themes |
| | and includes the name that theme. |
| Can you think of a situation where you could | These are behavioral prompts of the situational |
| make a difference at our company? | sub-type. The interviewer expresses curiosity |
| If you knew we interviewed 30 candidates with | about a hypothetical or past situation. Cues |
| more experience, what would you say to | include use of the words “if”, “suppose”, |
| convince us to hire you? | “situation”, and “example” and a description of |
| Please share a time where you had the skills | a situation. One technique for responding |
| and talent to do something, but the opportunity | directs the interviewee to determine what |
| never presented itself. | theme is implied by the prompt and to provide |
| Give me an example of where you convinced | a simple answer, retell an experience summary |
| others of an idea or belief of yours. | that includes the theme, and provide at least a |
| If you could present any topic to a large | portion of the summary list of themes of that |
| audience, what subject would you talk about? | experience summary. |
| Suppose you came across a person near the | |
| factory who was screaming in pain and holding | |
| his eyes, what would you do? | |
| Why do you want to change employers? | These are behavioral prompts of the open |
| What aspects of your work do you get the most | ended sub-type. The prompt implies that the |
| excited about? | interviewee has freedom to provide a full |
| How does your experience and education | explanation including related topics. Cues |
| qualify you for this position? | include curiosity about the interviewee's level |
| How has your previous job prepared you to | of passion, motivation, feelings, views, or |
| take on greater responsibility for this job? | decisions about a topic. One technique for |
| Why did you choose this profession and this | responding directs the interviewee to state one |
| specific job? | or more themes as a complete answer and |
| | answer a follow-up question by retelling a |
| | suitable experience summary. In both answers, |
| | the interviewee does not permit himself or |
| | herself to go beyond a succinct answer. |
| What means of communication may be used to | These are behavioral prompts of the |
| effectively establish a new company policy? | communication sub-type. The interviewer |
| How do you effectively communicate with | expresses a curiosity about the compatibility of |
| others? | the interviewee with others. Cues include use |
| What are the important qualities a person | of the words “others”, “team”, |
| should have to become an effective team | “commumcation”, “motivation”, “interaction |
| member? | with others”, “speak”, “listen”, “convey”, and |
| What are some of the characteristics of a good | “employee involvement38 . One technique for |
| listener? | responding directs the interviewee to state as a |
| What motivates employees? | complete answer one or more themes; and, in a |
| | follow up question retell a suitable experience |
| | summary. |
| What makes you more qualified than the other | These are behavioral prompts of the job sub- |
| candidates? | type. The interviewer seeks to reveal the |
| What are your strong points and how have they | interviewee's emotional views pertaining to a |
| helped you to succeed? | job related topic. Cues include addressing |
| What is the most difficult assignment you have | career related issues without reference to |
| had? | technical skills, prompting for self-evaluation |
| What are your three greatest strengths? | of skills or past performance. One technique |
| Describe yourself. | for responding directs the interviewee to |
| | recognize whether stating a theme would be a |
| | complete answer or retelling an experience |
| | summary would be a complete answer; and |
| | then responding as discussed above. |
| Suppose that your manager has given you an | These are behavioral prompts of the ethics sub- |
| assignment that will require you to work late | type. The interviewer may present a situational |
| tonight; however, you have concert tickets for | or open ended prompt as discussed above, |
| you and your spouse tonight. What will you | except that the prompt limits the interviewee's |
| do? | choice of action in the situation or subject |
| Your co-worker continually comes to you to | matter in the open ended prompt. The |
| complain about management. Your supervisor | interviewer seems to be probing whether the |
| seems to be paying particular attention to the | interviewee's answer will be consistent with |
| two of you. How will you handle this | prior answers. Cues include subject matter that |
| situation? | overlaps moral choices, ethical choices, |
| Rate yourself from one to ten on your work | guidelines that are traditional to culture, family |
| ethic with ten being the best. | heritage, religious beliefs, legal limits, or |
| What do you think the employee's | business practices. One technique for |
| responsibilities are to the company? | responding directs the interviewee to recognize |
| A vendor comes in to thank you for assistance | a theme that is strongly related to the subject of |
| in clearing up a past due invoice. The vendor | the prompt, and retell an experience summary |
| offers you two tickets to a ball game. What | that names and demonstrates that theme. |
| will you do? | |
| What are the advantages, if any, of | These are behavioral prompts of the goals sub- |
| establishing team goals as opposed to | type. The interviewer attempts to determine if |
| individual goals? | the interviewee is one who establishes goals |
| What do you wish to gain from our company | and if he or she takes actions necessary to |
| and how will you do it? | achieve goals. Cues may include use of the |
| What steps have you taken in the past two | words “establishing”, “goals”, “steps you have |
| years to improve your qualifications? | taken“, ”plan“, and “wish” accompanied with |
| What are your career goals? | “how”. Cues include inquiries pertaining to |
| Five years from now, where do you want to | the interviewee's achievements or measurable |
| be in your career? | actions over time. One technique for |
| How will the job you're interviewing for fit | actions over time. One technique for |
| into your career plans? | responding directs the interviewee to retell an |
| | experience related to planning, persistence, and |
| | follow through, for example, where he or she |
| | took specific actions to plan and accomplish a |
| | goal, followed by summary statements of |
| | related themes. |
| How much time are you willing to spend | These are manipulative prompts of the lifestyle |
| driving to work? | sub-type. The interviewer attempts to |
| How familiar are you with the community that | determine whether the interviewee has |
| we're located in? | preferences that are inconsistent with |
| Will you relocate? | completing the duties of the position sought. |
| You mentioned you're an avid skier, how often | Cues include prompts about relocation, travel, |
| do you go to the mountains to ski? | housing, communities, commuting, and |
| How long do you intend to stay here? | hobbies. One technique for responding directs |
| | the interviewee to assert that there is nothing |
| | prevents the interviewee from successfully |
| | completing the duties of the position sought. |
| Which is more important to you, the money or | These are manipulative prompts of the “or” |
| the type ofjob? | sub-type. The interviewer intends to force the |
| Do you mind commuting or do you want to be | interviewee into a category that the interviewer |
| close to work? | has defined. The interviewee may become |
| Do you work better by yourself or as part of a | stressed because he or she is not able to guess |
| team? | which category the interviewer values. The |
| Would you prefer to work in management or as | interviewer may intend to cause stress to |
| a technical lead? | determine how the interviewee acts under |
| Do you normally spend more time working by | stress. Cues include use of the word “or”; and |
| yourself or with a group? | statements concluded with “isn't that right?”. |
| | One technique for responding directs the |
| | interviewee to assert that all of the alternatives |
| | apply and state one or more themes to support |
| | that conclusion. Another technique directs the |
| | interviewee to assert that none of the |
| | alternatives apply and state one or more |
| | contrasting themes to support that conclusion. |
| | In either technique, the response may include |
| | retelling an experience summary and providing |
| | a summary list of themes in a conclusion. |
| Have you ever been caught doing something | These are manipulative prompts of the “off the |
| you knew was wrong? | wall” sub-type. The interviewer intends to |
| Name the greatest risk you've taken. | evaluate the interviewee's self-confidence in a |
| If you were a cucumber in a salad and | situation having ambiguities and uncertainties. |
| somebody was about to eat you, what would | Cues include the lack of an obvious |
| you do? | relationship between the prompt and any of the |
| How do you deal with risk on the job? | interviewee's themes; the lack of an obvious |
| What is your favorite color and what does it | relationship between the prompt and skills |
| reflect in your personality? | related to the industry and position sought; and |
| | prompts about risk taking. One technique for |
| | responding directs the interviewee to call |
| | attention to the prompt itself by repeating it |
| | back to the interviewer for clarification. |
| | Another technique directs the interviewee to |
| | ask how the subject matter relates to duties of |
| | the position sought. Yet another technique is |
| | to respond with one or more themes, an |
| | experience summary, and a summary list of |
| | themes, as discussed above. |
| What salary are you seeking? | These are manipulative prompts of the salary |
| How much money will it take to get you into | sub-type. The interviewer implies that a |
| our company? | suitable answer to a prompt about rewards or |
| Can we have your decision now? | compensation is a prerequisite to deciding |
| We'd like to offer you this job at 5% over your | whether to extend an offer to the interviewee. |
| prior salary. What do you say? | Cues include use of the words “salary”, |
| What are the most important rewards you | “rewards”, “pay”, “compensation”, “stock”, |
| expect in your career? | and “incentives”. One technique for |
| | responding directs the interviewee to explain |
| | that he or she will discuss compensation only |
| | after an offer has been made and to ask for the |
| | offer. |
| Tell me about a time when you tried and | These are manipulative prompts of the |
| failed? | weakness sub-type. The interviewer attempts |
| Tell me about an unsuccessful event that you | to evaluate the interviewee's self-confidence |
| participated in? What, if anything, could you | through probing matters and topics that may |
| have done differently? | cause the interviewee to feel uneasy. Cues |
| What is the toughest part of a job for you? | include prompts about past difficulty, |
| Explain the greatest risk that you've taken | unsatisfactory conditions, or failure. Cues may |
| that resulted in failure. | include use of the words “failure”, “failed”, |
| Explain your three greatest weaknesses. | “unsuccessful”, “challenging”, “toughest”, |
| What past action on the job are you now least | “weakness”, “undesirable”, “least”, and |
| proud of? | “unproductive”. |
| | One technique for responding directs the |
| | interviewee to recall a theme that has been |
| | learned by experience and then retell the |
| | experience, followed by summary statements |
| | of related themes. |
| Does your religion prevent you from working | These are illegal prompts. The interviewer |
| weekends or holidays? | purposefully or mistakenly prompts for |
| Are you considered to be part of a minority | information that if used by the employer as a |
| group? | basis for refusing employment may constitute |
| Have you ever had instances of muscle | an unlawful employment practice, for example, |
| fatigue? | violation of a civil right protected by the |
| Has any of your relatives had any history of | constitution. Cues include subject matter such |
| memory loss? | as religion, political preference, race, criminal |
| Have you discussed working in Texas with | record, physical health or treatment, mental |
| your child? | health or treatment, age, marital status, |
| | pregnancy, child care, and sexual preferences. |
| | One technique for responding directs an |
| | interviewee to ask if the prompt is a |
| | requirement of the position sought. If the |
| | prompt seems legal, then to respond by stating |
| | one or more themes possibly followed by |
| | retelling an experience summary. Otherwise, |
| | to respond without providing information that |
| | could be used illegally. |
| What aspect of your education applies to this | These are subject matter prompts. The |
| position? | interviewer attempts to evaluate the |
| Your resume says you know Microsoft | interviewee meets objective, for example |
| software. How long have you used it? | quantitative, criteria related to duties of the |
| When you worked on the XYZ project, what | position sought. Cues include achievements in |
| technical skills did you utilize? | education, certification, years of experience, |
| There are only two companies listed on your | experience with specific tools, systems, or |
| resume. What other experiences have utilized | software. One technique for responding directs |
| your abilities and skills? | the interviewee to simply answer the prompt |
| If you're preparing for a trade show, how much | truthfully, expressing enthusiasm about the |
| time would you normally take to set it up? | achievement and positive comment or |
| | interesting detail about the subject matter. |

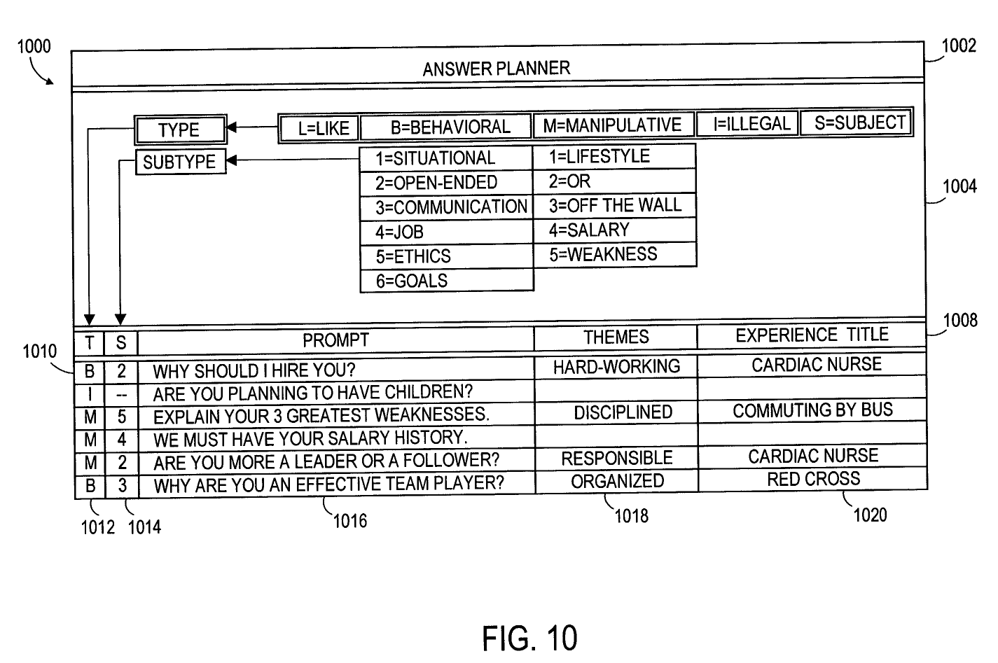

A process for learning answering technique includes any method for equipping a student to respond to prompts. One technique for responding that generally applies to all prompts discussed above, is discussed below with reference to FIG. 3. For example, process 246 may include receiving categorically organized descriptions of prompts (e.g., as in Table 2); and completing one or more worksheets to gain facility in recognizing cues, recalling themes, and recalling brief experiences. A worksheet of the format shown in FIG. 10 may be used.

Worksheet 1000 includes heading 1002, guidelines section 1004, and a table 1008 having rows 1010. Each row 1010 includes column 1012 for student entry of prompt type, column 1014 for student entry of prompt sub-type, column 1016 stating a prompt, column 1018 for student entry of one or more themes that may be used to answer the prompt, and column 1020 for student entry of one or more experiences that may be used to demonstrate the themes. Preferably, for each row, one experience is identified in column 1020 to demonstrate all themes listed in column 1018 of the same row. Table 1008 is ordinarily blank except for prompts listed in column 1016. As shown, columns 1012 and 1014 are filled in to demonstrate use of guidelines 1004. By completing worksheet 1000 for several mixes of prompts, a student may recognize that themes and experiences have general utility in answering a wide variety of prompts. Identification of a prompt may be rather loosely accomplished because the same answering technique may apply regardless of the specific category of prompt. By discovering these aspects of interview prompts, the student may gain confidence in interviewing.

A process for answering a prompt includes any method for recalling themes and experiences and retelling the themes, experiences, or both in answer to the prompt. For example, method 150 of FIG. 3 includes a process 302 for recognizing a category and call of a prompt; a store 242 of prompt categories and cues; a process 304 for recognizing an opportunity to prove themes of the interviewee's personal inventory of themes; a store 122 of experience summaries and summary lists of themes; a process 306 for recalling themes related to a category, call, or opportunity recognized by processes 302 and 304; a process 308 for recalling an experience summary; a process 310 for answering the prompt by retelling an experience from an experience summary; a process 312 for recalling a summary list of themes from an experience summary; and a process 314 for answering the prompt or for concluding an answer by stating members of the summary list recalled by process 312.

Process 150 may refer to a worksheet 1000 when an interviewer's question or the opportunity of the moment presents a prompt already analyzed in advance by the student in a worksheet 1000. Process 302 may refer to information organized as in store 242 and Table 2 discussed above. Processes 302 and 304 may refer to cues as discussed above with reference to Table 2. Process 306 may refer to a student's personal inventory of themes as recorded in section 910 and/or 924 of several worksheets 900 in store 122 and/or in column 510 of worksheet 500. Process 308 may refer to section 922 of a worksheet 900 of an experience identified by themes from process 306. Process 312 may refer to section 924 of a worksheet 900 of an experience identified by themes from process 306. When answering a question, a student may perform process 314 alone; process 310 alone; or. preferably when time and interest by the interviewer permit, a brief answer according to process 314, a demonstration of proof by process 310, followed by a conclusion (e.g., a summary, recap, re-emphasis, or generalization) according to process 314.

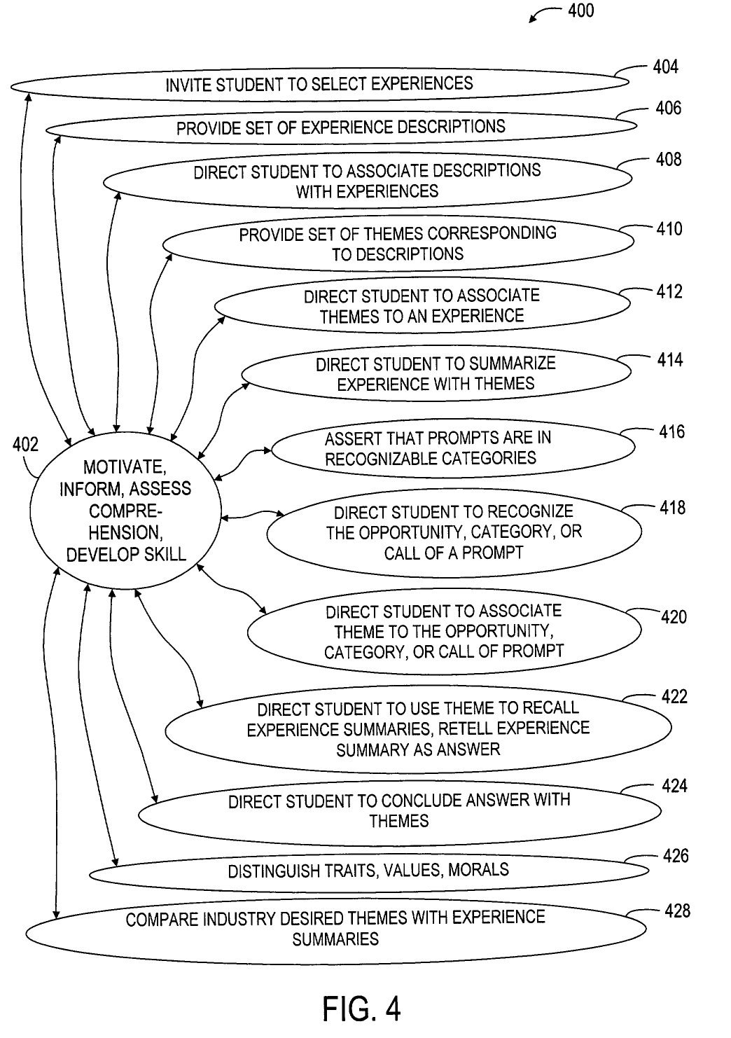

A method for teaching a student to answer a prompt while interviewing includes one or more methods that refer to themes as discussed above. For example, a method 400 of FIG. 4 includes processes that may be performed in any order and repeated as determined to be necessary by the teacher or as requested by the student. Methods for performing the following processes may include methods and acts as described above. The sequence of performing processes of method 400 defines an implementation of a system for teaching (e.g., a syllabus, curriculum, student's workbook, teaching handbook, or reference text for teaching interviewing). For example, method 400 includes a process 402 for motivating, informing, assessing a student's comprehension of material, and developing interviewing skills in the student (e.g., including any conventional teaching method discussed above); a process 404 for inviting a student to select experiences (e.g., related to processes 112, 114, 202, 204, or 222); a process 406 for providing a set of brief experience descriptions (e.g., 224 or 612); a process 408 for directing a student to associate descriptions with experiences (e.g., sections 604 and cols. 614-624); a process 410 for providing a set of themes corresponding to descriptions used in process 408 (e.g., worksheet 700 or Table 1); a process 412 for directing a student to associate themes to an experience (e.g., sections 904 and 910 of a worksheet 900); a process 414 for directing a student to summarize experiences with themes (e.g., section 922 of a worksheet 900); a process 416 for asserting that prompts are in recognizable categories (e.g., using Table 2 or various worksheets 1000); a process 418 for directing a student to recognize the opportunity presented by a prompt, the category of a prompt, or the call of a prompt (e.g., the call of a question) (e.g., using Table 2 with various worksheets 1000); a process 420 for directing a student to associate one or more themes to an opportunity, category, or call of a prompt (e.g., cols. 1016 and 1018 of worksheet 1000); a process 422 for directing a student to use one or more themes to recall one or more experiences (e.g., by recalling a title, a summary, or both) and to retell the experience summary as an answer to the prompt (e.g., reciting the experience summary 922 verbatim; or reciting a portion of the summary 922 having terminology expressing a theme, that is a theme name); a process 424 for directing a student to conclude his or her answer with one or more themes (e.g., reciting the summary list of themes 924 verbatim; or reciting a portion of section 910 or 924 expressing a theme verbatim); a process 426 for distinguishing personality traits, values, and morals as types of themes (e.g., worksheet 800); and a process 428 for comparing industry desired themes with a student's experience summaries (e.g., using worksheet 500 as discussed above with reference to process 238). Information provided by the student in any of the above processes may be used in process 400 as a prompt to repeat another process so as to refine the student's interviewing skill.

Process 400 may be conducted by a system for teaching that includes instructions to the student. An instruction includes any guidance, assertion, prompt, direction, command, invitation, or question. Teaching includes, among other things, providing a series of instructions. An instruction may be provided by a teacher or by a teaching aid (e.g., by directions associated with a worksheet, by self paced learning materials, or by computer aided education). A teacher may be a person serving as a tutor, instructor, coach, or facilitator. A system for teaching may include any combination of teaching aids and instructions to the student. Teaching may be as a one-to-one tutorial or as one-to-many seminar (e.g., lectures and recitation exercises by one or more instructors with a group of students learning in concert). Any conventional distance learning technology may be used.

The foregoing description discuss preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A system for teaching interviewing comprising:
means for obtaining decisions by a student whether provided descriptions of experience are true for an experience of the student;
cross-referencing means for cross-referencing from the descriptions of experience to personality traits;
recording means for recording a writing by the student, the recording means comprising a first region for a list of the personality traits obtained via the cross-referencing means, and a second region for a summary of the experience;
a first means for teaching that directs the student to make decisions in cooperation with the means for obtaining decisions;
a second means for teaching that directs the student to make entries in the regions of the recording means in accordance with the decisions; and
a third means for teaching that directs the student to retell the summary of the experience in answer to a question during an interview.

2. The system of claim 1 wherein the recording means further comprises a third region for a summary list comprising the personality traits obtained via the cross-referencing means.

3. The system of claim 2 wherein the summary list further comprises at least one of values and morals that the student has determined are demonstrated by the experience.

4. The system of claim 2 further comprising a fourth means for teaching that directs the student to retell at least part of the summary list in answer to the question during the interview.

5. The system of claim 1 further comprising entering means for automatically entering personality traits into the first region in accordance with the means for obtaining decisions and in accordance with the cross-reference means.

6. The system of claim 1 further comprising a memory device comprising indicia of at least one of the means for obtaining, the cross-referencing means, the recording means, the first means for teaching, the second means for teaching, and the third means for teaching.

7. The system of claim 1 further comprising transmitting means for transmitting across a network link indicia of at least one of the first means for teaching, the second means for teaching, and the third means for teaching.

8. A method for teaching interviewing, the method comprising:
a step for inviting the student to select experiences;
a step for directing the student to associate provided brief descriptions with selected experiences;
a step for providing a set of themes corresponding to the brief descriptions for use in associating members of the set of themes with the selected experiences, wherein each member of the set of themes comprises at least one of a moral, a personality trait, and a value;
a step for directing the student to prepare a description of each selected experience using members of the set of themes associated with the respective experience;
a step for directing the student to recall a particular experience that was associated with the particular theme; and
a step for directing the student to respond to the prompt by retelling the description of the recalled particular experience.

9. The method of claim 1 further comprising:
a step for asserting that prompts are in recognizable categories;
a step for directing the student to associate themes with prompts; and
a step for directing the student to respond to a particular prompt by:
recognizing the category of the particular prompt; and
recalling the particular theme that had been associated with the particular prompt.

10. The method of claim 1 further comprising:
a step for directing the student to, after retelling, state at least one theme that had been associated with the experience.
